(19) United States
(12) Patent Application Publication
(10) Pub. No.: US 2004/0244706 A1
(43) Pub. Date: Dec. 9, 2004

(54) Animal breeding material or article

(75) Inventors: Masahiko Kurauchi, Tokyo (JP); Kiyonori Furuta, Kawasaki-shi (JP); Hiroyuki Sato, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: AJINOMOTO CO. INC., Tokyo (JP)

(21) Appl. No.: 10/748,149

(22) Filed: Dec. 31, 2003

Related U.S. Application Data
(63) Continuation of application No. PCT/JP02/04934, filed on May 22, 2002.

(30) Foreign Application Priority Data
Jul. 10, 2001 (JP) 2001-209284

(51) Int. Cl. A01K 29/00

(52) U.S. Cl. 119/161

(57) ABSTRACT

The present invention relates to an animal breeding material or article having excellent antibacterial properties, deodorization characteristics and safety. More particularly, the present invention relates to an animal breeding material or article composed of a basic amino acid cellulose partial ester (i.e., partial ester of cellulose with a basic amino acid) or a salt thereof as the effective constituting component.

### CROSS-REFERENCE TO RELATED APPLICATIONS

The present application is a continuation application of International PCT application No. PCT/JP02/04934, filed May 22, 2002, which claims priority to Japanese Application No. JP 2001-209284, filed on Jul. 10, 2001, which are hereby incorporated by reference in their entirety.

### BACKGROUND OF THE INVENTION

1. Field of the Invention

The present invention relates to an animal breeding material or article having excellent antibacterial properties, deodorization characteristics and safety. More particularly, the present invention relates to an animal breeding material or article composed of a basic amino acid cellulose partial ester (i.e., partial ester of cellulose with a basic amino acid) or a salt thereof as the effective constituting component.

2. Discussion of the Background

Hitherto, sand, chaff, sawdust, paper and similar materials have been used as an underlay to facilitate disposal of excrements, remnants of feed, etc., during breeding of pets such as dogs, cats, and birds and other animals. However, from a practical viewpoint, use of these materials is not always preferred due to the proliferation of bacteria and the occurrence of offensive smells.

As an attempt to solve these problems, Japanese Patent Application Laid-Open (Kokai) No. 6-14669 discloses zeolite particles coated with bentonite as excrement disposal sand for pets. However, the bentonite-coated zeolite particles are incombustible, which gives rise to disposal and dumping problems due to their incombustibility.

Furthermore, Japanese Patent Application Laid-Open (Kokai) No. 8-70724 discloses a sheet for pets wherein a roasted coffee bean extraction residue is employed. Unfortunately, a repugnant behavior may result depending on the type and general demeanor of the animal due to the offensive smells peculiar to the roasted coffee bean extraction residue.

In addition, Japanese Patent Application Laid-Open (Kokai) No. 2000-316693 and Japanese Patent Laid-Open No. 2001-57931 disclose antibacterial deodorant sheets wherein a non-woven fabric containing the metal salt of an organic compound as an antibacterial and mildew-resistant component is employed. However, the antibacterial deodorant sheets are disadvantageous since the antibacterial and mildew-resistant performance is exhibited by the antibacterial component, which is dissolved or eluted in the water contained in excrements or the like of an animal during use. As a result, living bodies and the environment may be adversely affected when this component is dissolved or eluted.

### SUMMARY OF THE INVENTION

It is an object of the present invention to provide an animal breeding material or article that is free from any of the aforementioned problems associated with the materials currently employed in the art and is excellent in antibacterial properties, deodorization characteristics and safety.

The present inventors have found that the above object can be achieved by constituting or composing all or part of an animal breeding material or article with a basic amino acid cellulose partial ester, or a salt thereof, which has the antibacterial activity.

Accordingly, the present invention provides an animal breeding material or article having excellent antibacterial properties, deodorization characteristics and safety. In particular the animal breeding material or article is composed of a basic amino acid cellulose partial ester or a salt thereof as the effective constituting component.

The above objects highlight certain aspects of the invention. Additional objects, aspects and embodiments of the invention are found in the following detailed description of the invention.

### DETAILED DESCRIPTION OF THE INVENTION

Unless specifically defined, all technical and scientific terms used herein have the same meaning as commonly understood by a skilled artisan in animal breeding sciences.

All methods and materials similar or equivalent to those described herein can be used in the practice or testing of the present invention, with suitable methods and materials being described herein. All publications, patent applications, patents, and other references mentioned herein are incorporated by reference in their entirety. In case of conflict, the present specification, including definitions, will control. Further, the materials, methods, and examples are illustrative only and are not intended to be limiting, unless otherwise specified.

In an embodiment of the present invention is an animal breeding material or article with a basic amino acid cellulose partial ester, or a salt thereof, which has the antibacterial activity.

As used herein, the inventive animal breeding material or article refers to a material or article that is used by placing or laying in a cage or the like or applying onto an animal body during the breeding of an animal for the purpose of facilitating the disposal of excrements (feces and urine), preventing offensive smells, or the like.

In the present invention, the basic amino acid cellulose partial ester or a salt thereof has a chemical structure where the carboxyl group of a basic amino acid and the hydroxyl group(s) of cellulose are subjected to dehydration to form a covalent bond (ester bond), and hence the possibility of elution by the liquid secreted, exuded, or excreted from a living body is low. Moreover, even when the ester bond is cleaved, the component that is removed from the cellulose is an amino acid, which is harmless to a living body, so that the inventive animal breeding material or article is extremely high in safety.

In one embodiment of the present invention, the basic amino acid cellulose partial ester or a salt thereof according to the present invention has a lysine, arginine, omithine, or histidine residue as the basic amino acid moiety. Accordingly, the basic amino acid cellulose partial ester may be a lysine cellulose partial ester, an arginine cellulose partial ester, an ornithine cellulose partial ester or a histidine cellulose partial ester. Here, the basic amino acid may be, of course, a mixed amino acid.

The degree of substitution for esterification of the basic amino acid cellulose partial ester or a salt thereof may range from 0.00001 to less than 3. As used herein, the degree of substitution for esterification is defined as the number of the amino acids forming the ester bond per one of the glucose residues constituting cellulose, the amino acids being bound through ester bond to cellulose. When the degree of substitution for esterification is outside the aforementioned range, only an insufficient antibacterial activity is exhibited.

Several type of salts may be employed within the present invention, for example, organic acid salts such as an acetate, a lactate, a malate, a tartrate, a succinate, a citrate, a benzoate, a pyrrolidonecarboxylate, and the like, inorganic acid salts such as a hydrochloride, a sulfate, a phosphate, and the like, and Lewis acid salts such as zinc chloride, and the like.

An exemplary method for producing the basic amino acid cellulose partial ester includes the following method. Namely, cellulose is first brought into contact with a treating agent solution containing a basic amino acid ester, and then, after the liquid component is suitably removed according to need, the resulting product is dried. Thereafter, the alcohol moiety of the basic amino acid ester is exchanged with cellulose (ester exchange reaction, i.e., transesterification) by a heating treatment, and then post-treatment such as washing or the like is carried out in order to remove the unreacted basic amino acid ester. Further, in a step after the heating treatment, the basic amino acid cellulose partial ester can be converted into the salt with the acid, by using any acid.

In greater detail, as the treating agent solution in the present invention a solution obtained by dissolving a basic amino acid ester, preferably a lower alkyl ester having 1 to 6 carbon atoms including a methyl ester as a representative, in water, an alcohol or a mixture thereof is used. In the case where the basic amino acid ester is in the form of a salt with hydrochloric acid, sulfuric acid, or the like, the salt may be neutralized, if necessary, with an alkali metal or alkaline-earth metal hydroxide, an alkali metal or alkaline-earth metal carbonate, an alkali metal or alkaline-earth metal hydrogencarbonate, an organic amine, or the like, in an amount of 10 to 200 mol % based on the basic amino acid ester.

The content ratio of the basic amino acid ester in the treating agent solution is any ratio insofar as the ratio is within the range where the ester can be dissolved or dispersed in the above water, alcohol, or a mixture thereof.

Cellulose is immersed in the treating agent solution, and after the liquid component is suitably removed according to need, the resulting product is dried and then thermally processed at 100 to 200° C., preferably 120 to 180° C., for 10 seconds to 100 minutes, preferably 1 to 60 minutes, whereby transesterification takes place. Thereafter, the unreacted basic amino acid ester is removed by washing, followed by obtaining a final product of the basic amino acid cellulose partial ester, via a drying step. The washing after the thermal processing can be carried out in the order of firstly washing with water, then washing with an aqueous solution of an organic acid such as citric acid or the like, and finally washing with water, but some of them may be optionally omitted. When the washing is carried out with an aqueous solution of an organic acid, the final product is in the form of an organic acid salt of a basic amino acid cellulose partial ester, because the basic amino acid ester bound to cellulose through an ester bond forms a salt therewith.

The present invention is relates to an animal breeding material or article which is composed of such a basic amino acid cellulose partial ester or a salt thereof as the constituting component effective for the purpose of antibacterial properties, deodorization characteristics and safety. Specifically, such an animal breeding material or article may be any one insofar as the basic amino acid cellulose partial ester or a salt thereof in the form of fabric, non-woven fabric, fiber, powder or the like, is arranged or incorporated as at least part of the animal breeding material or article, and a hitherto known structure may be adopted as the other part thereof. For example, in the case of the animal breeding material or article, such as an antibacterial deodorant pad for an animal, for the purpose of absorbing the liquid secreted, exuded, or excreted from a living body, the inventive basic amino acid cellulose partial ester or a salt thereof, e.g., in the fibrous or powdery form, may replace all or part of the absorptive body or material in a hitherto known structure.

Having generally described this invention, a further understanding can be obtained by reference to certain specific examples, which are provided herein for purposes of illustration only, and are not intended to be limiting unless otherwise specified.

### EXAMPLES

### Production Example 1

Production of L-lysine cellulose partial ester citrate (non-woven fabric)

In 15 ml of methanol 2.33 g (10 mmol) of L-lysine methyl ester dihydrochloride was dissolved, followed by the addition of 5 ml of 2N aqueous sodium hydroxide solution to prepare a treating agent solution. In the treating agent solution 5.0 g of a cotton non-woven fabric (“CX32” manufactured by Haniron K.K.) was immersed and the fabric was air-dried for 1 hour and subsequently heat-treated at 140° C. for 20 minutes. The resulting fabric was washed with water, followed by washing with 5% aqueous sodium bicarbonate and rinsing with water repeatedly three times, followed by washing with 10% aqueous citric acid solution and rinsing with water repeatedly three times, and then, after removal of the water, air-dried to prepare a sample.

After a part of the sample was removed and dried overnight at 50° C. under vacuum, an approximately 0.5 g portion thereof was accurately weighed and subjected to alkaline hydrolysis with constant stirring in 50 ml of 0.5N sodium hydroxide at room temperature for 18 hours. After the fibers were filtered off, the L-lysine in the filtrate was quantitatively determined using an amino acid analyzer (Hitachi Ltd., “L-8500”). Based on the results, the bound amount of L-lysine per 1 g of the sample was calculated and found to be 0.105 mmol. Moreover, based on the results of the quantitative determination by HPLC, of the citric acid in the same filtrate, the bound amount of the citric acid per 1 g of the sample was calculated and found to be 0.190 mmol.

### Production Example 2

Production of L-Arginine Cellulose Partial Ester Citrate (Non-Woven Fabric)

Production Example 1 was repeated except that 2.61 g (10 mmol) of L-arginine methyl ester dihydrochloride was used instead of the L-lysine methyl ester dihydrochloride. In a similar manner to the method in Production Example 1, the bound amounts of the L-arginine and the citric acid per 1 g of the sample were calculated and found to be 0.109 mmol and 0.162 mmol, respectively.

### Production Example 3

Production of L-Lysine Cellulose Partial Ester Citrate (Powder)

A treating agent solution was prepared by mixing 2.32 g (10 mmol) of L-lysine methyl ester dihydrochloride, 5 ml of 2N aqueous sodium hydroxide solution, and 40 ml of methanol. After 10.0 g of a microcrystalline cellulose “Avicel FD-101” (manufactured by Asahi Kasei Corporation) was added to the treating agent solution, the mixture was concentrated at 40° C. under reduced pressure using a rotary evaporator (heated on an oil bath) until the solvent was completely removed by evaporation. An oil bath was elevated in temperature to 140° C. and maintained at the same temperature for 10 minutes. After the thermally treated mass was cooled to room temperature, 40 ml of water was added thereto to disperse the mass, and then the dispersed mass was suction-filtered and washed. This operation was repeated once more, and then the resulting product was similarly washed with 40 ml of 10% aqueous citric acid solution. After washing again with 40 ml of water, the washed product was dried under reduced pressure, whereby 9.92 g of a powder was obtained. The bound amount of the L-lysine per 1 g of the sample was calculated by the method described in Production Example 1 and was found to be 0.084 mmol. Moreover, a peak was confirmed for the ester bond at 1720 to 1740 cm⁻¹ on the IR spectroscopic analysis.

### Production Example 4

Production of L-Arginine Cellulose Partial Ester Citrate (Powder)

Production Example 3 was repeated except that 2.61 g (10 mmol) of L-arginine methyl ester dihydrochloride was used instead of the L-lysine methyl ester dihydrochloride. In a similar manner to the method described in Production Example 1, the bound amount of the L-arginine per 1 g of the sample was calculated and found to be 0.054 mmol. Moreover, a peak was confirmed for the ester bond at 1720 to 1740 cm⁻¹ on the IR spectroscopic analysis.

### Example 1

Each non-woven fabric of Production Examples 1 and 2 was used as an antibacterial deodorant sheet for an animal. Moreover, antibacterial deodorant pads could be prepared by wrapping a highly water-absorbing polymer or the like with such a sheet. Furthermore, excrement-treating materials were prepared for an animal or underlay for an animal from each powder of Production Examples 3 and 4 or by suitably mixing it with wood-pulp or the like, followed by molding according to need.

### Test Example 1

Antibacterial Activity Test

An antibacterial activity test was performed on the non-woven fabric or powder of Production Example 1, 2, 3, or 4 in accordance with the procedure described in “JIS L 1902:1998 under “Test Procedures for Antibacterial Activity of Fiber Products”, at 8. Quantitative determination test”. As test bacteria were used Staphylococcus aureus ATCC 6538P and Klebsiella pneumoniae ATCC 4352. After each specimen was sterilized with a high-pressure vapor, a given amount (about 2.5×10⁴) of each bacterium suspended in a Nutrient Broth medium was inoculated and cultured at 37° C. for 18 hours. The living cells were subsequently counted for each bacterium.

Proliferation values, bacteriostatic values, and bactericidal activity values were calculated from the formulae described in JIS L 1902:1998, i.e., F=M_{b}−Mₐ, S=M_{b}−M_{c}, and L=Mₐ−M_{c}, provided that F: proliferation value, S: bacteriostatic value, L: bactericidal activity value, Mₐ: common logarithm value of the number of the living cells on unprocessed specimens immediately after inoculation, the said number being the average for three specimens, M_{b}: common logarithm value of the number of the living cells on unprocessed specimens after 18 hours of culture, the said number being the average for three specimens, and M_{c}: common logarithm value of the number of the living cells on processed specimens after 18 hours of culture, the said number being the average for three specimens. The results are shown in the following Tables 1 to 4.

TABLE 1
Results of antibacterial activity test on the non-woven fabric
of Production Example 1

| Test bacterium | Staphylococcus aureus | Klebsiella pneumoniae |
|---|---|---|
| (Storage No.) | (ATCC 6538P) | (ATCC 4352) |
| Inoculant bacterium | 2.5 × 10⁴ | 2.5 × 10⁴ |
| concentration (cells/ml) | | |
| Number of the living | <20 | <20 |
| cells | | |
| after 18 hours (cells/ml) | | |
| Proliferation value (F) | 2.8 | 3.3 |
| Bacteriostatic value (S) | >5.9 | >6.4 |
| Bactericidal activity | >3.1 | >3.1 |
| value (L) | | |

TABLE 2
Results of antibacterial activity test on the non-woven fabric
of Production Example 2

| Test bacterium | Staphylococcus aureus | Klebsiella pneumoniae |
|---|---|---|
| (Storage No.) | (ATCC 6538P) | (ATCC 4352) |
| Inoculant bacterium | 2.5 × 10⁴ | 2.5 × 10⁴ |
| concentration (cells/ml) | | |
| Number of the living | 1.9 × 10² | <20 |
| cells | | |
| after 18 hours (cells/ml) | | |
| Proliferation value (F) | 2.8 | 3.3 |
| Bacteriostatic value (S) | 4.9 | >6.4 |
| Bactericidal activity | 2.1 | >3.1 |
| value (L) | | |

TABLE 3
Results of antibacterial activity test on the non-woven fabric
of Production Example 3

| Test bacterium | Staphylococcus aureus | Klebsiella pneumoniae |
|---|---|---|
| (Storage No.) | (ATCC 6538P) | (ATCC 4352) |
| Inoculant bacterium | 2.5 × 10⁴ | 2.5 × 10⁴ |
| concentration (cells/ml) | | |
| Number of the living | <20 | <20 |
| cells | | |
| after 18 hours (cells/ml) | | |
| Proliferation value (F) | 3.0 | 3.1 |
| Bacteriostatic value (S) | >5.9 | >6.2 |
| Bactericidal activity | >2.9 | >3.1 |
| value (L) | | |

TABLE 4
Results of antibacterial activity test on the non-woven fabric
of Production Example 4

| Test bacterium | Staphylococcus aureus | Klebsiella pneumoniae |
|---|---|---|
| (Storage No.) | (ATCC 6538P) | (ATCC 4352) |
| Inoculant bacterium | 2.5 × 10⁴ | 2.5 × 10⁴ |
| concentration (cells/ml) | | |
| Number of the living | <20 | <20 |
| cells bafter 18 | | |
| hours (cells/ml) | | |
| Proliferation value (F) | 3.0 | 3.1 |
| Bacteriostatic value (S) | >5.9 | >6.2 |
| Bactericidal activity | >2.9 | >3.1 |
| value (L) | | |

From the aforementioned tests, it was confirmed that the non-woven fabric or powder of Production Example 1, 2, 3, or 4 exhibits a sufficient antibacterial activity.

### Test Example 2

Deodorization Test

A deodorization test was performed with the non-woven fabric of Production Example 1. Ammonia and acetic acid were used as the target gas for measurement, and the initial concentrations thereof were 40 ppm and 100 ppm, respectively. After 1.0 g of the specimen was placed in a 5 L tedler bag, 3 L of each target gas for measurement was injected. The gas concentrations after 2 hours and 24 hours were measured by means of a detecting tube. As the detecting tube, No. 3L (manufactured by K.K. Gastec) was used for the ammonia and No. 81 (manufactured by K.K. Gastec) for the acetic acid. The results are shown in the following Tables 5 and 6. In the tables, the processed product, the unprocessed product (control), and the blank (blank test) mean the non-woven fabric of Production Example 1, the non-woven fabric before processing, and the test performed with nothing being placed in the bag, respectively.

TABLE 5
Results of deodorization test for ammonia on the non-woven
fabric of Production Example 1

Concentration of ammonia (ppm)

| | Initial | After | After |
|---|---|---|---|
| Sample | concentration | 2 hours | 24 hours |
| Processed product | 40 | <0.5 | <0.5 |
| Unprocessed | 40 | 19 | 11 |
| product (control) | | | |
| Blank (blank test) | 40 | 33 | 20 |

TABLE 6
Results of deodorization test for ammonia on the non-woven
fabric of Production Example 1

Concentration of acetic acid (ppm)

| | Initial | After | After |
|---|---|---|---|
| Sample | concentration | 2 hours | 24 hours |
| Processed product | 100 | 7.9 | 4.8 |
| Unprocessed | 100 | 9.1 | 7.1 |
| product (control) | | | |
| Blank (blank test) | 100 | 72 | 42 |

From the aforementioned tests, it was confirmed that the non-woven fabric of Production Example 1 exhibits sufficient deodorization characteristics.

### Test Example 3

Elution Test

An elution test was performed by shaking a 0.422 g piece of the non-woven fabric produced in Production Example 1 in 10 ml of water at room temperature. As the result of analysis of the eluted components by HPLC, elution of the L-lysine was observed in an amount of 0.0098 mmol after 1 hour and 0.0130 mmol after 5 hours per 1 g of the piece. However, no eluted substance other than L-lysine was observed.

### INDUSTRIAL APPLICABILITY

As demonstrated by the Examples above, the present invention provides an animal breeding material or article which is excellent in antibacterial properties, deodorization characteristics and safety, and composed of a basic amino acid cellulose partial ester or a salt thereof as the effective constituting component.

Numerous modifications and variations on the present invention are possible in light of the above teachings. It is, therefore, to be understood that within the scope of the accompanying claims, the invention may be practiced otherwise than as specifically described herein.

1. An animal breeding material or article comprising a basic amino acid cellulose partial ester or a salt thereof as the effective constituting component.

2. The animal breeding material or article of claim 1, wherein said basic amino acid cellulose partial ester or a salt thereof is in a form selected from the group consisting of fabric, non-woven fabric, fiber and powder.

3. The animal breeding material or article of claim 1, wherein said basic amino acid cellulose partial ester has a chemical structure wherein the carboxyl group of a basic amino acid and the hydroxyl group(s) of cellulose are subjected to dehydration to form a covalent ester bond.

4. The animal breeding material or article of claim 1, wherein the basic amino acid cellulose partial ester has a basic amino acid moiety selected from the group consisting of lysine, arginine, omithine, and histidine.

5. The animal breeding material or article of claim 4, wherein the basic amino acid cellulose partial ester is selected from the group consisting of a lysine cellulose partial ester, an arginine cellulose partial ester, an omithine cellulose partial ester and a histidine cellulose partial ester.

6. The animal breeding material or article of claim 1, wherein the basic amino acid cellulose partial ester has a degree of substitution for esterification ranging from 0.00001 to less than 3.

7. The animal breeding material or article of claim 1, wherein the basic amino acid cellulose partial ester is in a salt form.

8. The animal breeding material or article of claim 7, wherein the salt of the salt form of the basic amino acid cellulose partial ester is an organic acid salt selected from the group consisting of an acetate, a lactate, a malate, a tartrate, a succinate, a citrate, a benzoate, and a pyrrolidonecarboxylate.

9. The animal breeding material or article of claim 7, wherein the salt of the salt form of the basic amino acid cellulose partial ester is an inorganic acid salt selected from the group consisting of a hydrochloride, a sulfate, and a phosphate.

10. The animal breeding material or article of claim 7, wherein the salt of the salt form of the basic amino acid cellulose partial ester is a Lewis acid salt.

11. The animal breeding material or article of claim 10, wherein the Lewis acid salt is zinc chloride.

12. In a method of breeding animals where the improvement comprises employing an animal breeding material or article of claim 1 as an antibacterial deodorizing agent for animals selected from the group consisting of an excrement disposing agent for animals, an underlay for animals, an antibacterial deodorant sheet and an antibacterial deodorant pad.

13. A method of making an animal breeding material or article comprising:
a) dissolving a basic amino acid ester, or a salt thereof, in water or an alcohol, or a mixture thereof to form a treating solution;
b) immersing cellulose in said treating solution;
c) drying the product of (b);
d) thermally processing the dried product at a temperature ranging from 100 to 200° C. for a time ranging from 10 seconds to 100 minutes;
e) recovering a basic amino acid cellulose partial ester.

14. The method of claim 13, wherein said basic amino acid ester is a lower alkyl ester having 1 to 6 carbon atoms.

15. The method of claim 13, wherein said basic amino acid ester is in a salt form.

16. The method of claim 13, wherein said thermal processing is at a temperature ranging form 120 to 180° C.

17. The method of claim 13, wherein said thermal processing is for a time ranging from 1 to 60 minutes.

18. The method of claim 13, wherein said recovering a basic amino acid cellulose partial ester comprises:
i) removing any unreacted basic amino acid ester by washing; and
ii) drying the remaining basic amino acid cellulose partial ester.

19. The method of claim 18, wherein said washing comprises first washing with water, then washing with an aqueous solution of an organic acid, and finally washing with water.
